(19) United States
(12) Patent Application Publication
(10) Pub. No.: US 2003/0095279 A1
(43) Pub. Date: May 22, 2003

(54) Method and apparatus to reprint print data

(76) Inventor: Young-hye Kim, Gyeonggi-do (KR)

Correspondence Address: STAAS & HALSEY LLP, 700 11TH STREET, NW, SUITE 500, WASHINGTON, DC, 20001, US

(21) Appl. No.: 10/125,563

(22) Filed: Apr. 19, 2002

(30) Foreign Application Priority Data
Nov. 16, 2001 (KR) 2001-71400

(51) Int. Cl. B41F 1/00; G06F 15/00

(52) U.S. Cl. 358/1.14

(57) ABSTRACT

An apparatus and method to reprint print data includes a printer driver set to print the print data from an application program; and a bi-directional module storing the print data as a temporary file irrespective of an automatically uncorrectable error occurring during the printing of the print data, and controlling the printer driver to reprint the data from the temporary file without re-executing the application program.

### CROSS-REFERENCE TO RELATED APPLICATIONS

This application claims the benefit of Korean Application No. 2001-71400, filed Nov. 16, 2001, in the Korean Intellectual Property Office, the disclosure of which is incorporated herein by reference.

### BACKGROUND OF THE INVENTION

1. Field of the Invention

The present invention relates to a method and apparatus to reprint print data, and more particularly, to a method and apparatus to generate print data and reprint print data selected by a user without re-executing a corresponding application program or resetting a printer driver.

2. Description of the Related Art

In most cases, a computer and a printer are devices that are indispensable to office automation. The printer is a device that prints data created by an application program via a printer driver. The printer driver is a device or program to drive the printer.

The printer driver divides data created by an application program in a unit of a page to be generated as print data that can be recognized by the printer, and transmits the print data to the printer via a spooler. Therefore, the printer can print the data created by the application program.

Errors that occur during the printing of the print data are errors that result from print data spooled in the spooler that has not been deleted or a print job in progress that has not been canceled and result in the print data spooled in the spooler being deleted or a print job in progress being canceled, respectively. Such errors are referred to as “automatically uncorrectable errors” and generally occur when the printer is powered off, a print jam occurs, or a port that connects the printer to a computer is disconnected.

If the automatically uncorrectable error occurs during printing, the transmission of the print data from the computer to the printer is stopped, the print data spooled in the spooler is deleted or a print job in progress is canceled. Therefore, the user must correct the automatically uncorrectable error manually, reset the printer drive, and return to a pertinent application program to reprint the data.

Further, in the case that the automatically uncorrectable error occurs while printing several pages, it is inconvenient for the user to reprint data from the position where the error occurred because the print data has already been deleted or the pertinent print job has been canceled. Accordingly, the user has to return to the pertinent application program to reprint.

### SUMMARY OF THE INVENTION

Various objects and advantages of the invention will be set forth in part in the description that follows and, in part, will be obvious from the description, or may be learned by practice of the invention.

To solve the above problems, it is an object of the present invention to provide a data reprinting method in which a user does not need to return to a pertinent application program or reset a printer driver to print when errors occur during printing the data.

To achieve an aspect of the above object, there is provided a method of reprinting print data, including: printing the data from an application program; storing the data as a temporary file irrespective of an automatically uncorrectable error occurring during the printing of the data; and reprinting the data from the temporary file without re-executing the application program.

To achieve another aspect of the above objective, there is provided a method of reprinting print data, including: setting a printer driver to print the data from an application program; storing the data as a temporary file in a unit of a print job irrespective of an automatically uncorrectable error occurring during the printing of the data; and reprinting the data from the temporary file without re-executing the application program or resetting the printer driver.

According to another aspect of the present invention, a method of reprinting print data is provided, including: setting a printer driver to print the print data from an application program in response to a print command; spooling the print data in a unit of a page; storing spool data as a temporary file in a unit of a print job irrespective of an automatically uncorrectable error occurring during the printing of the spool data; and reprinting the print data from the temporary file corresponding to a command from a user without re-executing the application program or resetting the printer driver.

The automatically uncorrectable error includes at least one of a printer is powered off, a printer jam occurs, and a port that connects a computer and the printer is disconnected. The method further includes entering a command distinguishing between reprinting the data from a point where the automatically uncorrectable error occurred, reprinting the data from reprint the data from a first page, canceling the print job, and printing a predetermined page selected by a user. The temporary file contains information regarding print data and a page index and a size of the print data.

According to another aspect of the present invention, a method of reprinting print data is provided, including: storing the print data as a temporary file irrespective of an automatically uncorrectable error occurring during the printing of the print data from an application program; and reprinting the print data from the temporary file when the automatically uncorrectable error is corrected.

According to another aspect of the present invention, an apparatus to reprint print data, including: a printer driver set to print the print data from an application program; and a bi-directional module storing the print data as a temporary file irrespective of an automatically uncorrectable error occurring during the printing of the print data, and controlling the printer driver to reprint the data from the temporary file without re-executing the application program.

According to another aspect of the present invention, an apparatus is provided to reprint print data includes a printer driver set to print the data from an application program; and a bi-directional module storing the data as a temporary file in a unit of a print job irrespective of an automatically uncorrectable error occurring during the printing of the data, and controlling the printer driver to reprint the data from the temporary file without re-executing the application program or resetting the printer driver.

According to another aspect of the present invention, an apparatus is provided to reprint print data includes a bi-directional module storing the print data as a temporary file irrespective of an automatically uncorrectable error occurring during the printing of the print data from an application program, and controlling the printer driver to reprint the print data from the temporary file when the automatically uncorrectable error is corrected.

According to another aspect of the present invention, an apparatus is provided to reprint print data is provided including a printer driver printing the print data from an application program in response to a print command; a spooler spooling the print data in a unit of a page; a storage device; and a language monitor storing spool data in the storage device as a temporary file in a unit of a print job irrespective of an automatically uncorrectable error occurring during the printing of the spool data, and controlling the printer driver to reprint the print data from the temporary file corresponding to a command from a user without re-executing the application program or resetting the printer driver.

According to another aspect of the present invention, an apparatus is provided including a computer outputting print data; a printer printing the print data; a bi-directional module in the computer, storing the print data as a temporary file and receiving a detection signal indicative of whether an error has occurred during printing; and an interface module outputting a signal to the bi-directional module when the error includes an automatically uncorrectable error, wherein the signal corresponds to one of commanding to reprint the data in the temporary file from a page where the automatically uncorrectable error occurred, commanding to reprint a first page of the print data, commanding to cancel the print data from being printed, and a command from a user selecting at least one predetermined page to be printed.

These together with other objects and advantages, which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

The above objective and advantages of the present invention will become more apparent by describing in detail preferred embodiments thereof with reference to the attached drawings in which:

FIG. 1 is a block diagram of a printer system according to an embodiment of the present invention;

FIG. 2 is a diagram illustrating a method of formatting a temporary file according to an embodiment of the present invention; and

FIG. 3 is a flowchart of a method of reprinting data according to an embodiment of the present invention.

### DETAILED DESCRIPTION OF THE PREFERRED EMBODIMENTS

Hereinafter, embodiments of the present invention will be described in detail with reference to the attached drawings. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

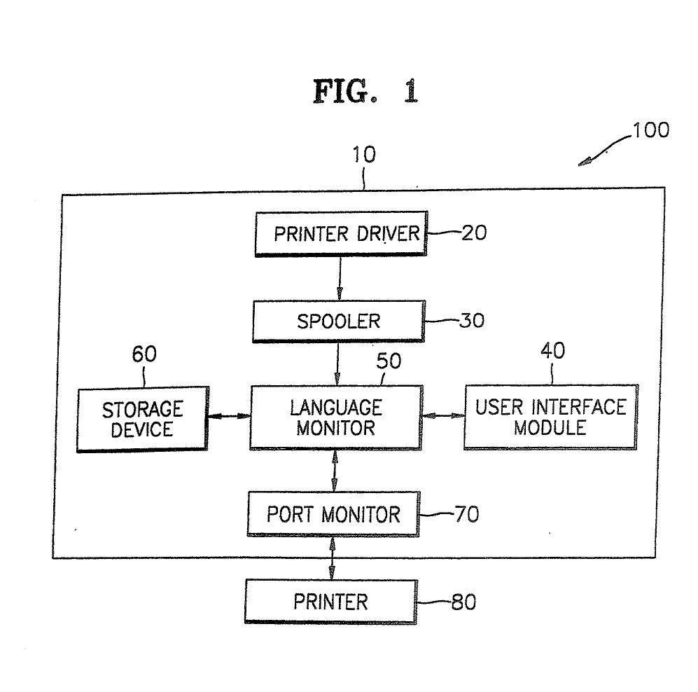

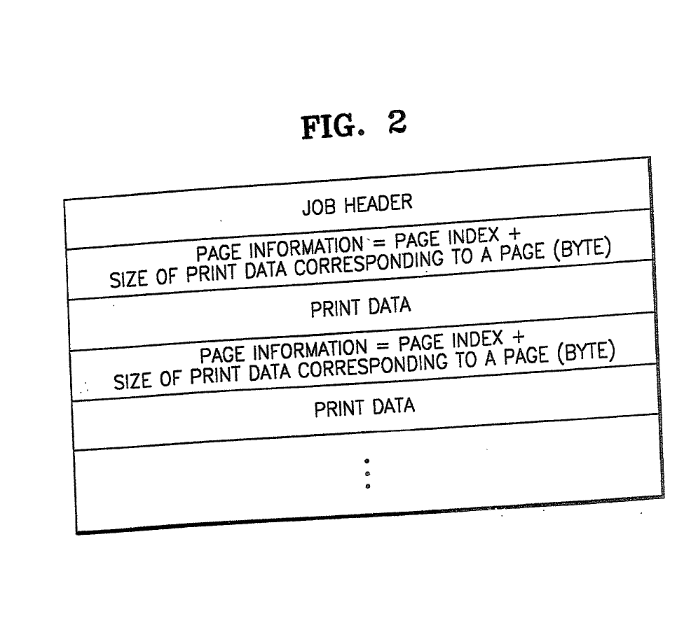

FIG. 1 is a block diagram of a printer system according to an embodiment of the present invention, and FIG. 2 is a diagram illustrating a method of formatting a temporary file according to an embodiment of the present invention.

Referring to FIG. 1, a printer system 100 includes a computer 10 and a printer 80. The computer 10 includes a printer driver 20, a spooler 30, a user interface module 40, a language monitor 50, a storage device 60 such as a memory, and a port monitor 70.

In general, a bi-direction communication is possible between the printer 80 and the computer 10. Specifically, the printer 80 detects whether print data is being normally printed, whether an error has occurred during the printing, or a type of error that has occurred, and transmits a detection result to the computer 10. Information regarding the operation of the printer 80 is sent to a bi-directional module such as the language monitor 50.

The printer driver 20 converts data created by an application program installed in the computer 10 into predetermined data that can be recognized by the printer 80, e.g., spool data, and outputs the predetermined data to the spooler 30. The spool data contains information regarding a job header and the print data, and page information as shown in FIG. 2. The job header includes information of a document or file being printed, and the page information presents a page index and a size of the print data of a pertinent page, i.e., byte. The spooler 30 is a program that manages spooling of the spool data output from the printer driver 20, and transmits the spool data to the language monitor 50, keeping pace with a processing speed of the printer 80.

The language monitor 50 stores the spool data from the spooler 30 in a predetermined region of the storage device 60 as the temporary file. The temporary file, according to an embodiment of the present invention, may be formatted as shown in FIG. 2. The language monitor 50, according to the present invention, may store the spool data as the temporary file until the pertinent print job is completed, irrespective of errors occurring during printing.

Further, the language monitor 50 commands the port monitor 70 to transmit print data thereto. Also, when the print job printing the print data is complete (EndDoc), the language monitor 50 removes or deletes the spool data stored as the temporary file from the storage device 60.

When an automatically uncorrectable error occurs in the printer 80 such as a printer jam and the error is corrected, the language monitor 50 outputs a signal to the user interface module 40. Specifically, the language monitor 50 outputs the signal to the user interface module 40, which stores the spool data as the temporary file, until the print job is completed.

Upon receipt of the signal from the language monitor 50, the user interface module 40 may open the temporary file and reprint the data from the page where the printer jam occurred, may reprint a first page of the data, cancel a print job in process, or allow the user through the user interface module 40 to reprint a predetermined page(s) selected by the user. Subsequently, the language monitor 50 responds to the user interface module 40 and executes the print job.

The storage device 60 stores the temporary file. The port monitor 70 controls an input/output port (not shown), which is electrically and physically connected with the printer 80, and outputs print data to the printer 80. Then, the printer 80 prints the print data in response to the print job.

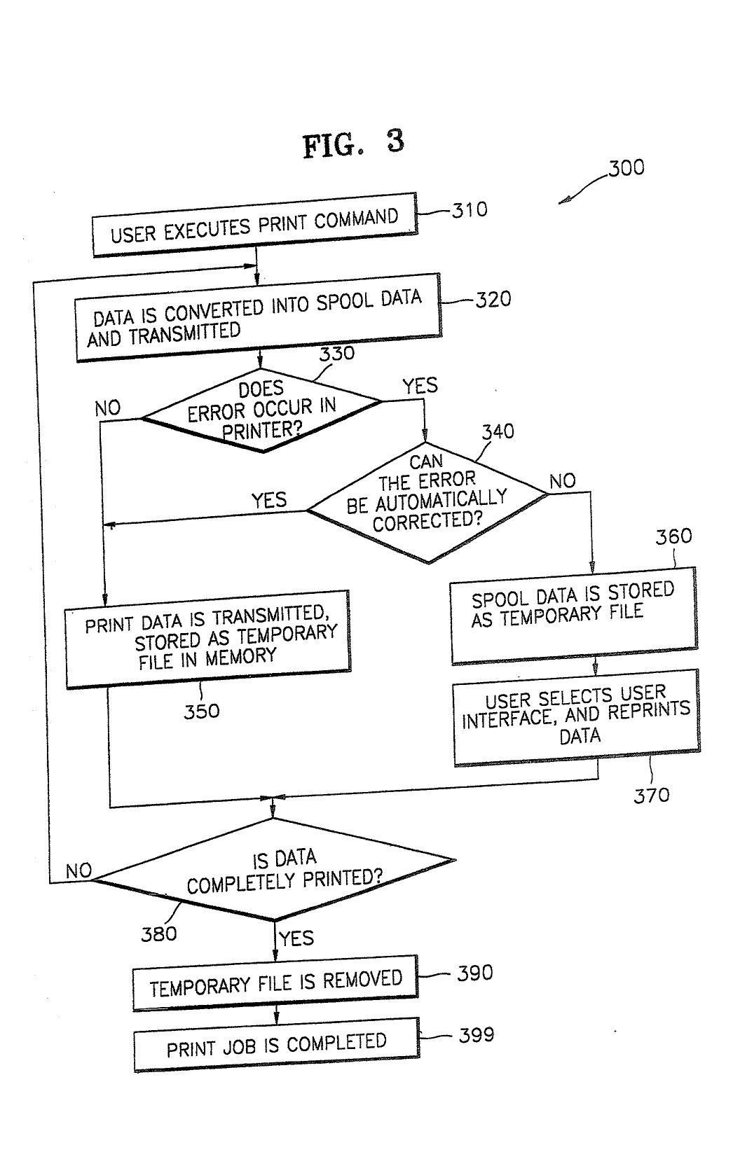

FIG. 3 is a flowchart of a method 300 of reprinting data according to an embodiment of the present invention. Hereinafter, the method 300 will now be described with reference to FIGS. 1 through 3.

At 310, the user executes a print command to output print data created by an application program to the printer 80. At 320, the printer driver 20 converts the print data into the spool data in response to the print command, and transmits the spool data in a unit of a page. At 330, the language monitor 50 checks an occurrence of an error in the printer 80 and stores the print data as the temporary file in the storage device 60 in a format as shown in FIG. 2. At 350, if an error did not occur, the language monitor 50 sends the print data to the port monitor 70 while generating the temporary file in the format as shown in FIG. 2. At 380, the language monitor 50 determines whether the print data is entirely printed (EndDoc). If the completion of the printing (EndDoc) is determined, at 390, the language monitor 50 removes the temporary file from the storage device 60 and, at 399, the language monitor 50 determines that the print job is complete. However, at 380, if it is determined that printing is in progress, the printer system 100 returns back to convert data into spool data 320.

If an error occurred, at 340, a determination is made whether the error is an automatically uncorrectable error. If the error does not cause the print data spooled in the spooler to be deleted or a print job in progress to be canceled, at 350, the language monitor 50 sends the print data to the port monitor 70 while generating a temporary file in the format as shown in FIG. 2. However, if the error causes the print data spooled in the spooler to be deleted or a print job in progress to be canceled, the language monitor 50 stores the spool data in the storage device 60 as a temporary file until the printjob is completed at 360. If an automatically uncorrectable error occurs, then the language monitor 50 calls the user interface module 40.

A user interface provided by the user interface module 40 is displayed on a monitor (not shown) of the computer 10. Therefore, at 370, the user can reprint data from the very page where the printer jam occurs, reprint a first page of the data, cancel the current print job, or reprint a predetermined page selected by the user.

In the case that the user corrects the automatically uncorrectable error, at 370, the language monitor 50 prints the page pertinent to the user interface selected by the user. At 380, the language monitor 50 checks the completion of the printing (EndDoc) according to print job. If it is determined at 380 that the printing is completed (EndDoc), the language monitor 50 deletes the temporary file from the storage device 60. On the contrary, at 380, if it is determined that the printing is in progress, the printer system 100 returns back to convert data into spool data 320.

In a method and apparatus of reprinting print data, according to the present invention, the user can reprint data without executing the pertinent application program again or resetting the pertinent printer driver even though spool data is deleted due to an error occurring during printing data. Also, because a user interface is provided to the user, the user can reprint from the very page where the error occurred, reprint from a first page of the data, print a predetermined page(s), or cancel the printing. Therefore, it is possible to reduce the amount of paper and time required to print.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of reprinting print data, comprising:
printing the data from an application program;
storing the data as a temporary file irrespective of an automatically uncorrectable error occurring during the printing of the data; and
reprinting the data from the temporary file without re-executing the application program.

2. The method as recited in claim 1, wherein the automatically uncorrectable error comprises at least one of a printer is powered off, a printer jam occurs, and a port that connects a computer and the printer is disconnected.

3. The method as recited in claim 1, further comprising:
entering a command distinguishing between reprinting the data from a point where the automatically uncorrectable error occurred, reprinting the data from reprint the data from a first page, canceling the print job, and printing a predetermined page selected by a user.

4. The method as recited in claim 1, wherein the temporary file contains information regarding print data and a page index and a size of the print data.

5. The method as recited in claim 1, wherein the storing of the data as the temporary file further comprises calling a user interface module.

6. The method as recited in claim 1, further comprising:
deleting the temporary file when the printing or the reprinting the data is complete.

7. The method as recited in claim 1, further comprising:
converting the data into spool data in response to a print command; and
transmitting the spool data in a unit of a page to a printer.

8. The method as recited in claim 1, wherein the data stored in the temporary file comprises spool data.

9. A method of reprinting print data, comprising:
setting a printer driver to print the data from an application program;
storing the data as a temporary file in a unit of a print job irrespective of an automatically uncorrectable error occurring during the printing of the data; and
reprinting the data from the temporary file without re-executing the application program or resetting the printer driver.

10. The method as recited in claim 9, wherein the automatically uncorrectable error comprises at least one of a printer is powered off, a printer jam occurs, and a port that connects a computer and the printer is disconnected.

11. The method as recited in claim 9, further comprising
entering a command distinguishing between reprinting the data from a point where the automatically uncorrectable error occurred, reprinting the data from reprint the data from a first page, canceling the print job, and printing a predetermined page selected by a user.

12. The method as recited in claim 9, wherein the temporary file contains information regarding print data and a page index and a size of the print data.

13. The method as recited in claim 9, wherein the storing of the data as the temporary file further comprises calling a user interface module.

14. The method as recited in claim 9, further comprising:
deleting the temporary file when the printing or the reprinting the data is complete.

15. A method of reprinting print data, comprising:
storing the print data as a temporary file irrespective of an automatically uncorrectable error occurring during the printing of the print data from an application program; and
reprinting the print data from the temporary file when the automatically uncorrectable error is corrected.

16. The method as recited in claim 15, wherein the storing of the data as the temporary file further comprises calling a user interface module.

17. The method as recited in claim 15, further comprising:
deleting the temporary file when the reprinting of the data is complete.

18. The method as recited in claim 15, wherein the automatically uncorrectable error comprises at least one of a printer is powered off, a printer jam occurs, and a port that connects a computer and the printer is disconnected.

19. The method as recited in claim 15, further comprising
entering a command distinguishing between reprinting the data from a point where the automatically uncorrectable error occurred, reprinting the data from reprint the data from a first page, canceling the print job, and printing a predetermined page selected by a user.

20. The method as recited in claim 15, further comprising:
converting the data into spool data in response to a print command; and
transmitting the spool data in a unit of a page to a printer.

21. The method as recited in claim 15, wherein the data stored in the temporary file comprises spool data.

22. A method of reprinting print data, comprising:
setting a printer driver to print the print data from an application program in response to a print command;
spooling the print data in a unit of a page;
storing spool data as a temporary file in a unit of a print job irrespective of an automatically uncorrectable error occurring during the printing of the spool data; and
reprinting the print data from the temporary file corresponding to a command from a user without re-executing the application program or resetting the printer driver.

23. The method as recited in claim 22, wherein the storing of the spool data as the temporary file further comprises calling a user interface module.

24. The method as recited in claim 22, further comprising:
deleting the temporary file when the print job is completed.

25. The method as recited in claim 22, wherein the automatically uncorrectable error comprises at least one of a printer is powered off, a printer jam occurs, and a port that connects a computer and the printer is disconnected.

26. The method as recited in claim 22, further comprising
entering a command distinguishing between reprinting the data from a point where the automatically uncorrectable error occurred, reprinting the data from reprint the data from a first page, canceling the print job, and printing a predetermined page selected by a user.

27. The method as recited in claim 22, wherein the temporary file contains information regarding print data and a page index and a size of the print data.

28. An apparatus to reprint print data, comprising:
a printer driver set to print the print data from an application program; and
a bi-directional module storing the print data as a temporary file irrespective of an automatically uncorrectable error occurring during the printing of the print data, and controlling the printer driver to reprint the data from the temporary file without re-executing the application program.

29. An apparatus to reprint print data, comprising:
a printer driver set to print the data from an application program; and
a bi-directional module storing the data as a temporary file in a unit of a print job irrespective of an automatically uncorrectable error occurring during the printing of the data, and controlling the printer driver to reprint the data from the temporary file without re-executing the application program or resetting the printer driver.

30. An apparatus to reprint print data, comprising:
a bi-directional module storing the print data as a temporary file irrespective of an automatically uncorrectable error occurring during the printing of the print data from an application program, and controlling the printer driver to reprint the print data from the temporary file when the automatically uncorrectable error is corrected.

31. An apparatus to reprint print data, comprising:
a printer driver printing the print data from an application program in response to a print command;
a spooler spooling the print data in a unit of a page;
a storage device; and
a language monitor storing spool data in the storage device as a temporary file in a unit of a print job irrespective of an automatically uncorrectable error occurring during the printing of the spool data, and controlling the printer driver to reprint the print data from the temporary file corresponding to a command from a user without re-executing the application program or resetting the printer driver.

32. An apparatus, comprising:
a computer outputting print data;
a printer printing the print data;
a bi-directional module in the computer, storing the print data as a temporary file and receiving a detection signal indicative of whether an error has occurred during printing; and
an interface module outputting a signal to the bi-directional module when the error comprises an automatically uncorrectable error, wherein the signal distinguishes between one of commanding to reprint the data in the temporary file from a page where the automatically uncorrectable error occurred, commanding to reprint a first page of the print data, commanding to cancel the print data from being printed, and a command from a user selecting at least one predetermined page to be printed.

33. The apparatus as recited in claim 32, wherein the bi-directional module deletes the print data stored when the printing or reprinting of the print data is complete.

34. The printer system as recited in claim 32, further comprising:
a printer driver converting the print data into spool data in response to a print command and transmits the spool data in a unit of a page to the bi-directional module.

35. The printer system as recited in claim 32, wherein the print data is stored as the temporary file irrespective of the occurrence of the automatically uncorrectable error.

36. The printer system as recited in claim 32, wherein when the error comprises an automatically corrected error, the bi-directional module automatically corrects the error and the print data is transmitted to the printer for printing.

37. The printer system as recited in claim 32, wherein the language monitor checks completion of the print job and removes the temporary file from the memory when the print job is completed.
